(19) United States
(12) Patent Application Publication
(10) Pub. No.: US 2005/0240952 A1
(43) Pub. Date: Oct. 27, 2005

(54) Lens driving device for optical read and/or write system and optical read/write system

(76) Inventors: Hendrik Josephus Goossens, EINDHOVEN (NL); Maria Bernardina Gertruda Cloosterman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/520,197

(22) PCT Filed: Jun. 13, 2003
(86) PCT No.: PCT/IB03/02833

§ 371 Date: Jan. 4, 2005

(30) Foreign Application Priority Data
Jul. 8, 2002 (EP) 02077720.7

(51) Int. Cl. G11B 7/085

(52) U.S. Cl. 720/659

(57) ABSTRACT

A lens driving device (1) or an optical read and/or write system comprises a mechanical structure (3) with an objective lens (2) and an actuator (4, 4′, 6) for controlling the lens position. The lens driving device comprises a further actuator (5, 5a, 5b, 5′) on or near the mechanical structure so as to at least partially compensate motion generated by the first-mentioned actuator (4,6).

### FIELD OF THE INVENTION

The invention relates to a lens driving device for an optical read and/or write system, comprising a mechanical structure having an objective lens, and an actuator for controlling the lens position by acting on the mechanical structure.

The invention also relates to an optical read and/or write system comprising a lens driving device comprising a mechanical structure having an objective lens, and an actuator for controlling the lens position by acting on the mechanical structure, the system further comprising a controller means for generating a control signal for the actuator, the actuator acting in response to the control signal.

### BACKGROUND OF THE INVENTION

Lens driving devices as well as optical read and/or write systems comprising lens driving devices are known. An optical read and/or write system reads information recorded on an optical medium, e.g. on a disk, using laser light to read/write a signal optically and/or write information on said optical medium. The lens driving device for such an optical read and/or write system drives an objective lens while position control of the lens, e.g. focus control and tracking control, are executed in accordance with the driving signals supplied to driving actuators, e.g. coils consisting of a focus coil and tracking coil wound on a holder provided with the objective lens. The lens driving device comprises a mechanical structure with an objective lens, usually on a holder which is generally suspended by suspension means. Actuators, for instance tracking and focusing coils on or near the mechanical structure e.g. on or near the lens holder in co-operation with magnets on a fixed part allow the position of the lens to be controlled, e.g. the lens holder can be moved in a radial direction (tracking) and a vertical direction (focusing). Alternatively, the device may have coils on a fixed part and magnet mechanical structure, e.g. on the lens holder. The lens driving device generally has respective resonance frequencies in the focus control and tracking movement, each resonance having a certain mode shape (characteristic movement of the structure at a resonance frequency). These natural resonance frequencies (eigenfrequencies) depend, inter alia, on the physical shape of the mechanical structure. This shape also determines the anti-resonances, e.g. frequencies where the movement of the mechanical structure at the position of the lens is very small due to cancelling effects of the different mode shapes. Such natural resonance and anti-resonance frequencies are typically situated around or slightly above 1 to 10 kHz.

In order to follow the tracks on the optical medium as accurately as possible, the bandwidth of the total system comprising the actuated mechanical system and a feedback controller must be as large as possible. However, the combinations of resonances and anti-resonances as described above are a limit to this bandwidth. In the case of these resonance and anti-resonance combinations, it is not possible in practice to design a simple (PID or PI-lead/lag) feedback controller, such that the total system has a loop gain that is smaller than 1 for the frequency where the phase is −180°, while the bandwidth of this system is in the region of the resonance/anti-resonance peaks. That is, if the loop gain comes close to −1, the system gets unstable and uncontrollable.

One way of avoiding these problems is to design the mechanical structure in such a way that its natural resonance frequencies lie at very high frequencies, such that the bandwidth of the controller can reach its specifications. The lens driving device is designed so that each higher mode resonance is out of each servoband. Namely, by designing the servoband necessary for actual servocontrol at an upper limit of e.g. 2 kHz-5 kHz, the control system is unaffected by the phase shift in the vicinity of the natural resonance frequency. EP 1 079 377 discloses a design aimed at achieving an increase of the natural resonance frequency. In recent years, however, the disk read and/or write systems have been operated at a high rotating speed of a disk that is several times the prevailing standard rotating speed of the disk. This increases the speed with which a signal is read and/or written by the lens driving apparatus for the disk player, and it also increases the driving speed, and thereby the driving frequencies of the drive. Thus there is a tendency that the upper limit in the servoband of the control system increases, leading to a need to increase the natural resonance frequency of the mechanical structure. This makes it often difficult to reach very high resonance frequencies, because of limitations on the space that can be occupied by the mechanical structure, or notwithstanding an increase of the natural resonance frequency, the increase of read/write speed also increases the upper limit (in frequency) of the servocontrol to a frequency approaching a natural resonance frequency.

### OBJECT AND SUMMARY OF THE INVENTION

It is an object of the invention to provide a lens driving device of the type described in the opening paragraph and an optical read and/or write system comprising a lens driving device with improved high frequency characteristics to reduce one or more of the indicated problems.

To this end, the lens driving device comprises a further actuator acting on the mechanical structure so as to generate at a frequency range a motion of or in the mechanical structure, to at least partially compensate motion generated by the first-mentioned actuator.

To this end, the optical read and/or write system comprises a lens driving system comprising a further actuator acting on the mechanical structure so as to generate at a frequency range a motion of or in the mechanical structure, to at least partially compensate motion generated by the first-mentioned actuator, the controller comprising means for generating a compensation signal for said further actuator.

The further actuator excites the mechanical structure at the same resonances as the first-mentioned actuators to compensate the motion caused by the first-mentioned actuator. In this manner, the resonances are actively cancelled, and the harmful oscillations are avoided. The lens driving system can be operated up to high frequencies.

In a preferred embodiment, the further actuator comprises a piezo-electric element. Within the broadest concept of the invention, the actuators may be e.g. a coil in combination with a magnetic system or e.g. a piezo-electric element. Use of a piezo-electric element is preferred because the further actuator is used at relatively high frequencies (the higher resonance frequencies), for which piezo-electric elements are well suited, and in general the additional weight caused by the further actuator is preferably small, and the weight of piezo-electric elements is generally smaller than the combined weight of a coil and magnet system. Furthermore, a piezo-electric element is generally smaller than an electromagnetic actuator comprising a coil and magnet system.

These and other aspects of the invention are apparent from and will be elucidated with reference to the embodiments described hereinafter.

### BRIEF DESCRIPTION OF THE DRAWINGS

In the drawings:

FIG. 1 illustrates a scheme for an optical read and/or write system in accordance with the invention,

FIG. 2 shows in a perspective view an embodiment of a lens driving device in accordance with the invention,

FIG. 3 shows in a perspective view another embodiment of a lens driving device in accordance with the invention,

FIG. 4 shows in a perspective view a further embodiment of a lens driving device in accordance with the invention,

FIG. 5 shows in a perspective view yet another embodiment of a lens driving device in accordance with the invention,

FIG. 6 shows a lens driving device in accordance with the invention, and

FIG. 7 illustrates in a graphical form the effects of the invention.

The Figures are not drawn to scale. Generally, identical components are denoted by the same reference numerals in the Figures.

### DETAILED DESCRIPTION OF PREFERRED EMBODIMENTS

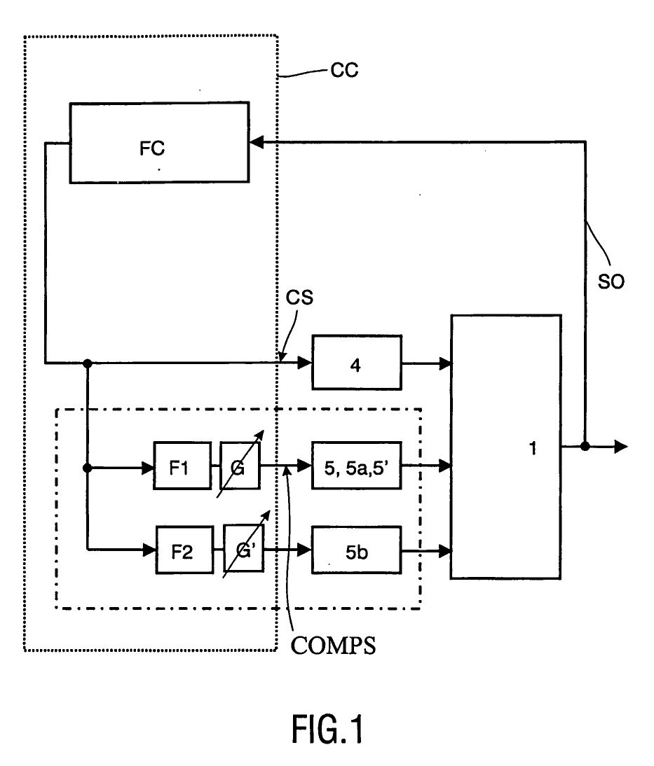

FIG. 1 schematically describes some elements of a system in accordance with the invention. On a mechanical structure 1, a lens is attached to a lens holder (not shown in the scheme, see for examples the following Figures). Attached to or near the mechanical structure is an actuator 4, which receives a control signal CS from a controller (in this example in the form of a control circuit CC). The input for the controller is a sensor output SO, which is fed in this example to a feedback controller (FC). These elements form the basic elements by which the position of the lens on the mechanical structure is controlled. However, the mechanical structure I has natural resonance frequencies (eigenfrequencies).

In order to follow the tracks on the optical medium as accurately as possible, the bandwidth of the total system comprising the actuated mechanical system and a feedback controller must be as large as possible. However, the combinations of resonances and anti-resonances as described above are a limit to this bandwidth. In the case of these resonance and anti-resonance combinations, it is not possible in practice to design a simple (PID or PI-lead/lag) feedback controller, such that the total system has a loop gain that is smaller than 1 for the frequency where the phase is −180°, while the bandwidth of this system is in the region of the resonance/anti-resonance peaks. That is, if the loop gain comes close to −1, the system gets unstable and uncontrollable.

One way of avoiding these problems is to design the mechanical structure in such a way that its natural resonance frequencies lie at very high frequencies, such that the bandwidth of the controller can reach its specifications. However, there is a limit to making the eigenfrequencies higher, especially in view of the constraints imposed on the design and the fact that the read/write speed becomes ever higher.

The invention has for its object to solve the above problems in a different manner. To this end, the lens driving device comprises a further actuator on or near the mechanical structure for acting on the mechanical structure so as to generate at a frequency range a motion of, or in the mechanical structure, at least partially compensate motion generated by the first-mentioned actuator.

A further actuator 5,5a,5′,5b is placed on or near the mechanical structure. It (they) will excite the mechanical structure at the same resonance frequencies as the actuator 4. By feeding a compensating controller signal COMPS to the further actuator(s) at a frequency range (to this end filters F may be provided) to the further actuator(s) as is shown in FIG. 1, unwanted resonances can be compensated. A gain G, which may be a tunable gain, may be provided to set the gain for the compensation signal. The gains may be different for different compensating actuators. This is schematically indicated in FIG. 1 by gain G′. Preferably, the further actuator is designed in such a way that it predominantly excites the resonance frequency that is to be cancelled.

By compensating the motion of actuator 4, the system remains stable and controllable, also when a controller is designed in such a way that the bandwidth of the system is near a resonance frequency of the mechanical system. It is noted that electronically eliminating the problem by using a notch filter in the control circuit (a filter that is specifically tuned to stop a particular frequency) can also avoid that the system becomes unstable. However, such notch filters have to be tuned for each device, and furthermore, ageing and temperatures effects may cause in time a mismatch between the eigenfrequency and the frequency of the notch filter. In the invention, such problems are smaller.

The filters used in the controller may be simple high-pass filters, or bandpass filters.

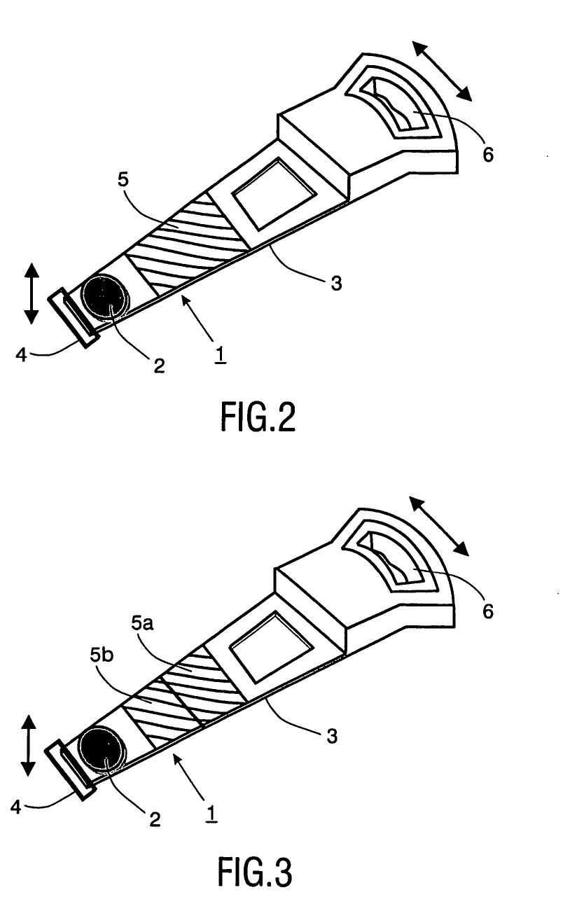

FIG. 2 shows schematically in a perspective view a lens driving device I in accordance with the invention. A lens 2 is positioned on a mechanical structure 3, in this embodiment a swing arm 3. A force is generated by coil 4 in the focus direction and by coil 6 in the radial direction. To suppress (compensate for) unwanted resonances of mechanical structure 3, an actuator, in this embodiment a thin piezo-electric element 5 is attached to mechanical structure 3. The permanent magnets which cooperate with the coils in generating the forces are not shown here. The coil may be positioned on the movable mechanical structure, in which case a permanent magnet system is positioned on a fixed part of the device, or alternatively, the permanent magnet system is attached to the mechanical structure, in which case the coils are positioned on a fixed part of the device. It is preferred, however, that the coils are attached to, fixed to or form part of the mechanical structure 3. The mechanical structure has a relatively smaller weight, which reduces the power dissipation and increases the resonance frequencies.

FIG. 3. shows a second embodiment. This embodiment comprises the same mechanical structure as shown in FIG. 2, except that the piezo-electric element 5 is divided into two separate zones 5a, 5b. By feeding these separate zones 5a, 5b through different filters i.e. at different frequency ranges (see FIG. 1) and/or by designing them in such a way that more resonances are excited, more than one resonance can be compensated.

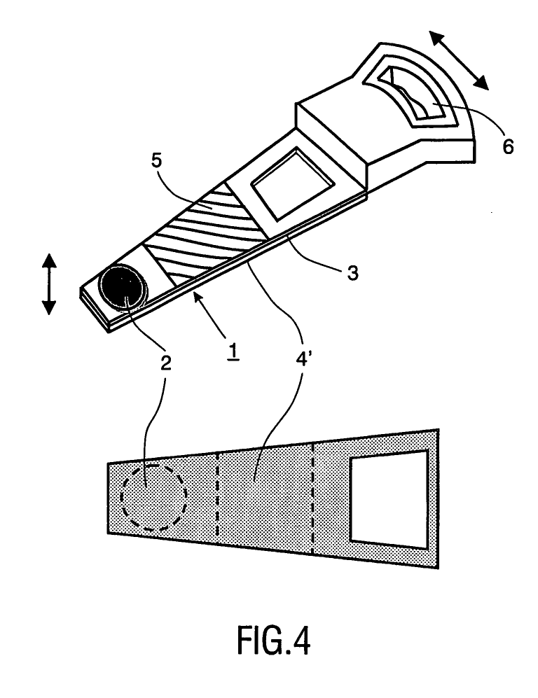

FIG. 4 shows yet a third embodiment, similar to the embodiment shown in FIG. 2, except that focus movement is not generated by a coil 4, but by a thin piezo-electric element 4′, for instance, glued on the bottom of the mechanical structure 2. The combination of piezo-electric elements 5 and 4′ makes the structure thinner and smaller, which in itself is an advantage. It is noted that the invention is to be understood to offer a route for reducing problems with resonances. The invention is not to be so restrictively interpreted as being unable to be combined with other measures of reducing problems with resonances. For instance, making the mechanical structure thinner and lighter (as in the example of FIG. 4) reduces the weight, thereby reducing power consumption. It may also lead to an increase of the resonance frequency, which is an advantage.

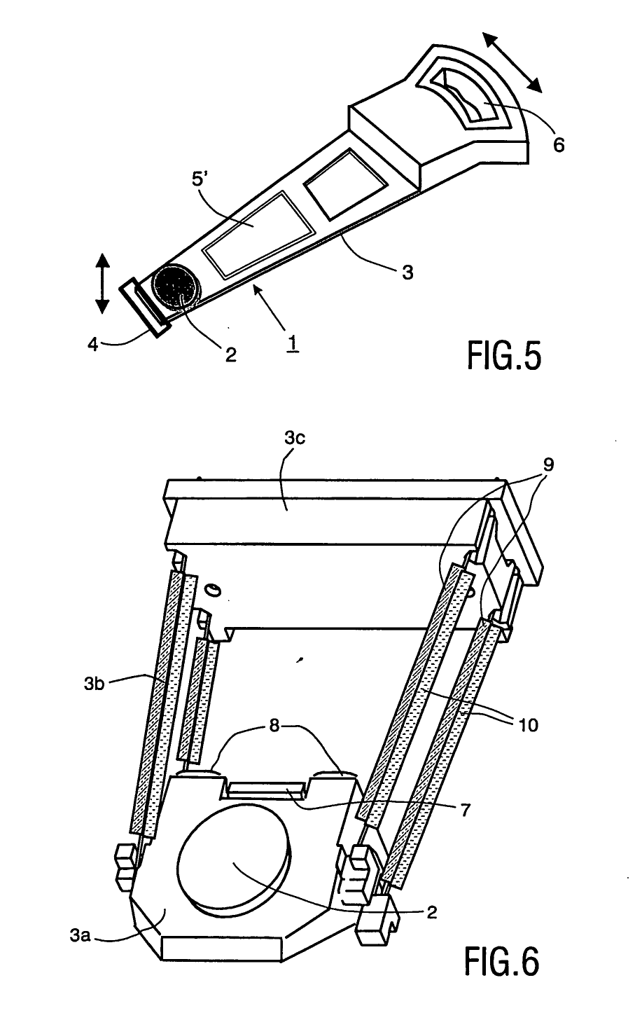

FIG. 5 shows yet a further embodiment of a lens driving device in accordance with the invention. It comprises the same actuators as in the embodiment shown in FIG. 2, but now the compensating actuator 5′ is an electromagnetic actuator, comprising a coil placed on top of the mechanical structure 3. A permanent magnet system (not shown here) for cooperation with the actuator 5′ is attached to the fixed housing for the swing arm.

A fifth embodiment is shown in FIG. 6. It comprises a lens 2 on a mechanical structure comprising a lens holder 3a, hinges 3b and a base 3c. The focusing and radial movements are generated by electromagnetic actuators of which only the permanent magnet system 7 and the radial coils 8 are shown. The resonance of the hinges during the focusing movement are reduced (compensated) by piezo-elements 9 on top of the hinges, while the resonances during radial movement are suppressed by piezo-electric elements 10.

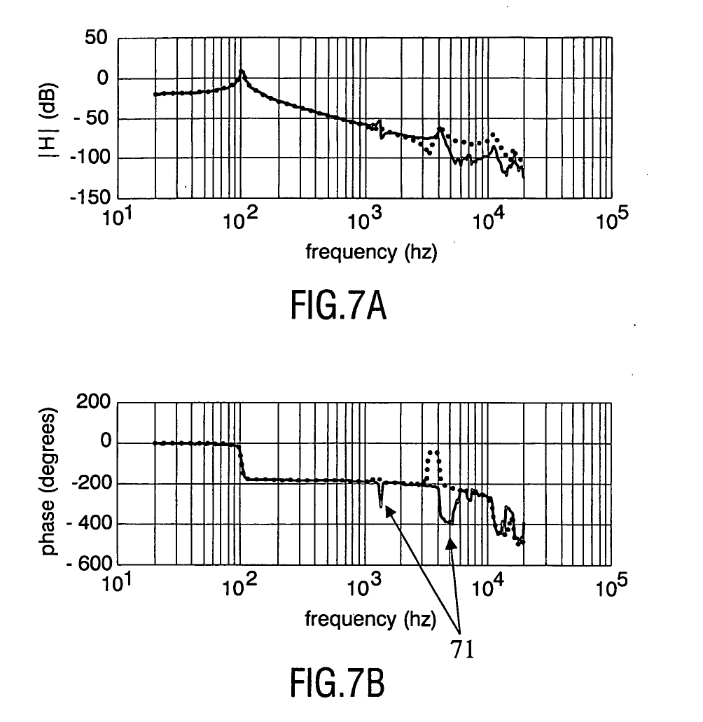

Finally, FIGS. 7A and 7B illustrate in a graphical form the effect of the invention. In this graph, experimental results are shown for an embodiment as schematically shown in FIG. 2. The horizontal axis denotes the frequency, whereas in the vertical direction gain (ratio of SO/CS in dB) is given (FIG. 7A), and the phase difference. Two lines are drawn, one (the solid line) without use of a compensating actuator, the other (the dotted line) with use of a compensating actuator. Two resonance frequencies at which the phase lag decreases below −180° are indicated by peaks 71a and b at around 1.4 kHz and around 5 kHz. These negative peaks in the phase cannot be compensated by e.g. simple PID (Proportional Integral Derivative) or PI-lead/lag controllers and thus limit the bandwidth of the total system. A system with a bandwidth near these peaks 71a and b would be unstable. The dotted line shows that use of the further actuator removes these peaks, and thereby removes the instabilities. It is noted that, in fact, both of the first instabilities are removed with a single actuator. The inventors have found that, compared to when use is made of an electronic notch filter, the resonance suppressing effect is more stable. Temperature or ageing effects are smaller. Experiments have also shown that overcompensation does not pose a major problem. Overcompensation has an effect as shown in FIGS. 7A and 7B for the second peak b. A phase lag (a negative phase difference ) is turned into a positive phase difference, which can be seen by the fact that the negative peak (to below −180 degrees) is turned into a positive peak (above the −180° line). In fact, supplying the further actuator with an overcompensating signal may be advantageous, because an added safety margin is then built in against instability. This is an advantage of the invention, and the compensating effect is robust, especially if a small overcompensation is used. Thermal effects and ageing effects have little influence. The filters may be broadband or high-pass filters (which are simple, cheap filters), and the gain g can vary between relatively large margins, while still a good result is achieved.

Addition of the further actuators to the mechanical structure has in itself an effect on the resonance frequencies of the mechanical structure. Therefore, the filter(s) F are chosen or set to match the mechanical structure with further actuators, as is (are) the gain(s).

While the invention has been described in connection with preferred embodiments, it will be understood that modifications thereof within the principles outlined above will be evident to those skilled in the art, and that the invention is thus not limited to one or more of the described embodiments but is intended to encompass such modifications.

One such modification is, for instance, an embodiment in which the gain(s) g are tunable (i.e. they have means for setting the gain of the signal for the further actuator) and the system has means for temporarily measuring, for instance, the phase lag within a frequency range, and retuning the gain in response to the measured phase lag.

The invention is embodied in each new characteristic feature and each combination of characteristics features. Any reference signs do not limit the scope of the claims. Use of the verb “comprise” and its conjugation does not exclude the presence of elements other than those stated in a claim. Use of the indefinite article “a” or “an” preceding an element does not exclude the presence of a plurality of such elements.

Within the concept of the invention a ‘controller means’ is to be broadly understood and comprise e.g. any piece of hardware (such as a controller, controller circuit), any circuit or sub-circuit designed for performing a controlling function as well as any piece of software (computer program or subprogram or set of computer programs, or program code(s)) designed or programmed to perform a controlling operation in accordance with the invention as well as any combination of pieces of hardware and software acting as such, alone or in combination, without being restricted to the embodiments described.

In summary, the invention may be described as follows.

A lens driving device (1) or an optical read and/or write system, comprises a mechanical structure (3) with an objective lens (2), and an actuator (4, 4′, 6) for controlling the lens position. The lens driving device comprises a further actuator (5, 5a, 5b, 5′) on or near the mechanical structure so as to at least partially compensate motion generated by the first-mentioned actuator (4,6).

1. A lens driving device for an optical read and/or write system, comprising a mechanical structure having an objective lens, and an actuator for controlling the lens position by acting on the mechanical structure, characterized in that the lens driving device comprises a further actuator on or near the mechanical structure for acting on the mechanical structure so as to generate at a frequency range a motion of or in the mechanical structure, to at least partially compensate motion generated by the first-mentioned actuator.

2. A lens driving device as claimed in claim 1, characterized in that the further actuator is designed in such a way that it predominantly excites the resonance frequency that is to be cancelled.

3. A lens driving device as claimed in claim 1, characterized in that the actuator comprises a piezo-electric element.

4. A lens driving device as claimed in claim 1, characterized in that the further actuator comprises a piezo-electric element.

5. An optical read and/or write system comprising a lens driving device comprising a mechanical structure having an objective lens, and an actuator for controlling the lens position by acting on the mechanical structure, the system further comprising a controller means for generating a control signal for the actuator, the actuator acting in response to the control signal, characterized in that the lens driving device comprises a further actuator on or near the mechanical structure for acting on the mechanical structure so as to generate at a frequency range a motion of or in the mechanical structure, to at least partially compensate motion generated by the first-mentioned actuator, the controller means comprising means for generating a compensation signal for said further actuator.

6. An optical read and/or write system as claimed in claim 5, characterized in that the further actuator is designed in such a way that it predominantly excites the resonance frequency that is to be cancelled.

7. An optical read and/or write system as claimed in claimed 5, characterized in that the actuator comprises a piezo-electric element.

8. An optical read and/or write system as claimed in claimed 5, characterized in that that the further actuator comprises a piezo-electric element.
